(19) United States
(12) Patent Application Publication
(10) Pub. No.: US 2020/0247104 A1
(43) Pub. Date: Aug. 6, 2020

(54) INSULATING PRODUCT

(71) Applicant: KNAUF INSULATION SPRL, Vise (BE)

(72) Inventors: Nicolas MARTIN, Vise (BE); Cyrille LERAT, Vise (BE)

(21) Appl. No.: 16/757,371

(22) PCT Filed: Oct. 18, 2018
(86) PCT No.: PCT/EP2018/078631

§ 371 Date: Apr. 17, 2020

(30) Foreign Application Priority Data
Oct. 19, 2017 (GB) 1717160.4
Jun. 5, 2018 (GB) 1809180.1

(51) Int. Cl. B32B 37/12; B32B 19/04; E04B 1/78

(52) U.S. Cl. CPC B32B 37/12; B32B 19/04; B32B 2419/00; B32B 2037/1253; B32B 2307/304; E04B 1/78

(57) ABSTRACT

The invention relates to the use of an adhesive in particulate form for securing a facing to a main surface of a mineral wool blanket.

This invention relates to a method of manufacturing a mineral wool insulating product comprising a mineral wool blanket and a facing secured to one of its main surfaces.

The invention is particularly useful in relation to a mineral wool insulating product which comprises a blanket of mineral fibres, for example glass fibres and/or stone fibres.

The fibres of such products are generally held together by a binder dispersed within the blanket to form a self-supporting blanket. The mineral wool fibre insulating product may be used as thermal and/or acoustic insulation, for example for buildings, or as insulated ducting, for example in heating or air conditioning systems.

Insulation products of this type are generally provided either as continuous lengths generally packaged as a roll or individual panels, or batts. A facing is often provided on one or both major surfaces of the insulation product. Depending upon the intended use, the facing may be permeable or may provide a gas and/or vapour barrier, and/or may have other functionalities including an encapsulation function and/or a reinforcing function and/or provide a soft touch or feel to the product. For example, a non-woven veil provided as a facing may be used to provide reinforcement and/or facilitate handling of the mineral wool blanket and a facing comprising a PET layer may be used to provide a vapour-barrier.

Facings are usually secured to the mineral wool blanket with:

a curable adhesive; or

a hot melt adhesive;

often applied in liquid form, for example in the form of a layer, notably a continuous layer or in the form of strips. However, the peel strength of facings attached with such systems has often proved to be less that desired, even when using significant quantities of adhesive. Indeed, the nature of the surface of the mineral wool blanket which is made up of a network of individual fibres separated by interstices results in particular challenges for ensuring desired levels of adhesion.

One aim of the present invention is to allow a facing to be secured to a mineral wool blanket in a way which provides advantageous levels of adhesion without requiring higher amount of adhesives and in a way that can be more easily implemented in an industrial mineral wool manufacturing process.

In accordance with one of its aspects, the present invention provides a method of manufacturing a mineral wool insulating product as defined in claim 1. Additional aspects of the invention are defined in independent claims. The dependent claims define preferred and/or alternative embodiments.

The facing may comprise, consist or consist essentially of: a glass veil, a woven veil, a woven glass veil, a non-woven veil, a non-woven glass veil, a coated veil, a kraft layer, a metallised layer, an aluminium layer, a PET layer, a plastics layer, a polymer layer, a polyethylene (PE) layer or a fibrous reinforcing scrim. The facing may comprise a plurality of different or identical layers, notably selected from the aforementioned. For example, the facing may comprise sequential layers of:

an aluminum layer, a PET layer and a reinforcing scrim; or

an aluminum layer, a PET layer and a kraft layer.

Alternatively, the facing may comprise a coated glass veil, notably a coated glass veil comprising a glass veil and an acrylic coating. The facing may also comprise a colouring agent and/or a filler, notably a colouring agent or a filler which darkens the colour of the facing. Preferably, the colouring agent provides a substantially black facing. Alternatively, the facing may be transparent or translucent.

The thickness of the facing may be ≥0.1 mm or ≥0.3 mm and/or ≤0.8 mm or ≤0.6 mm. Particularly when the facing comprises or consists essentially of a glass veil, the thickness of the facing may be ≥0.3 mm ands ≤0.6 mm. The method has been found to be particularly useful for securing such facings in a way which provides high peel strength whilst permitting the facing to conform to the surface of the mineral wool and retain desired flexibility.

The facing may have a surface weight ≥30 g/m² or ≥50 g/m² and/or ≤150 g/m² or ≤350 g/m². In one preferred embodiment of the invention, the facing comprises or consists essentially of a non-woven veil, notably a glass non-woven veil. Particularly where the facing is a woven facing, it may have a surface weight of in the range 100-150 g/m². Particularly when non-woven, the veil may have a surface weight of in the range 20-60 g/m².

As used herein, the term “consist essentially of” is intended to limit a definition or the scope of a claim to the specified materials or steps and those that do not materially affect the basic and novel characteristic(s) of the claimed invention.

The facing and/or one or more of its constituent parts, may comprise a fire or flame retardant. The insulation product may have a fire rating of A2 in accordance with EN 13501. In a preferred embodiment, the mineral wool insulating product has a fire rating of A1 in accordance with EN 13501, in force at the priority date of the present patent application. The ability to secure the facing using a small quantity of adhesive facilitates this.

As used herein, the term “particulate form” means in the form of solid particles.

The adhesive in particulate form may be selected from: polyethylene, polypropylene, copolyester PES, EVA, epoxy-polyester, a thermosetting adhesive and combination thereof.

The adhesive in particulate form may be applied to the facing by projection, for example by spraying the adhesive in particulate form towards and/or on to a major surface of the facing. The adhesive in particulate form may be applied to the facing by coating, for example by roller coating.

The amount of adhesive applied to the facing may be ≥5 g/m² or ≥10 g/m² and/or ≤30 g/m² or ≤25 g/m² or ≤20 g/m² or ≤15 g/m².

It has surprisingly been found that use of an adhesive in particulate form to secure the facing to the mineral wool blanket, particularly preferred adhesives, notably in the preferred quantities described herein, provides for an advantageous combination of:

i) good peel strength;
ii) homogeneity of peel strength over the surface of the mineral wool; and
iii) absence of undesired leakage of adhesive through the facing and/or at the edges of the facing,
with quantities of adhesive which are less that that that would be required to achieve equivalent properties using prior art adhesives. Whilst not wishing to be bound by theory, one possible explanation is that the adhesive in particulate form provides a form and/or distribution of adhesive on the major surface of the facing, notably once heated, which is particularly compatible with the surface structure of the mineral wool blanket.

Furthermore, use of an adhesive in particulate form may be used to reduce the duration during which heat is applied and thus to secure the facing more quickly than would be possible with a liquid adhesive and/or provide an adhesive system which is more tolerant to manufacturing variations.

The adhesive in particulate form may have a particle size such that ≥70%, ≥80% or ≥90% by weight of the particles have a particle size in the range: 20 μm to 550 μm; 20 μm to 350 μm; 20 μm to 150 μm; 70 μm to 350 μm; or 90 μm to 550 μm. The adhesive in particulate form may have an average particle size in the range 20-550 μm, preferably in the range 20-350 μm, more preferably in the range 20-150 μm, even more preferably in the range 70-150 μm.

The adhesive in particulate may be secured to the facing by applying heat to the adhesive and/or to the facing. Heat may be provided by a heated drum and/or one or more infrared heater(s) and/or by passing the facing through an oven. The parameters for temperature and duration during which the adhesive is exposed to heat are selected to secure the adhesive to the facing without damaging the facing. For example, when the adhesive is a thermoset adhesive, the parameters will be selected to avoid completely curing the thermoset adhesive. Preferably, the adhesive in particulate form is secured to the facing by applying a temperature of ≥50° C. and preferably of ≤250° C.

Securing of the adhesive in particulate form to the major surface of the facing provides an adhesive coated surface at the major surface of the facing. As used herein, the term “adhesive coated surface” means a surface to which an adhesive, notably such that the adhesive can serve to secure the surface to, for example, the mineral wool blanket. The adhesive coated surface of the facing may be formed so as to provide a facing which can be packaged, notably by rolling the facing, more notably in the form of a cylinder and subsequently unpackaged and unrolled prior to securing the adhesive coated surface of the facing to one of the main surfaces of the mineral wool blanket. The packaged facing may thus be stored and/or transported to a different site for use. The facing and/or the adhesive in particulate form may be selected for a particular type of mineral wool blanket such the different types of mineral wool blanket are manufactured using different types of facing and/or particulate adhesive. Off line manufacture of the facing provided with the particulate adhesive on an adhesive coated surface facilitates such variations and optimisations.

The adhesive coated surface of the facing may be secured to the mineral wool blanket prior to or subsequent to possible passage of the mineral wool through a curing oven to cure any binder in the mineral wool blanket. Notably when the particulate adhesive comprises a thermoplastic, for example a thermoplastic selected from polyethylene, polypropylene, copolyester PES, EVA and epoxy-polyester, the facing may be secured to the mineral wool blanket subsequent to any passage of the mineral wool blanket through a curing oven. The facing may be pressed between a main surface of the mineral wool blanket and a heated drum. The heated drum may have a surface temperature of ≥40° C., preferably 50° C. The facing may be pressed for duration which is ≥2 seconds, preferably ≥10 seconds and/or preferably ≤30 seconds. Notably when the adhesive comprises a thermosetting adhesive, the facing may be applied on the mineral wool blanket prior to passage of the mineral wool blanket through a curing oven. Passage of the mineral wool blanket through the curing oven may thus cure the binder present in the mineral wool blanket and secure the facing to the mineral wool blanket, notable by curing the particulate adhesive when the adhesive coated surface is in contact with a major surface of the mineral wool blanket. When passing through a curing oven, a portion of the curing oven may have a temperature of ≥180° C., preferably of ≥200° C. The time during which the facing is exposed to a temperature of ≥180° C., preferably of ≥200° C. may be ≥20 seconds, preferably ≥130 seconds and/or preferably ≤5 minutes.

The mineral wool blanket may comprise ≥80% wt, preferably ≥90% wt, more preferably ≥95% wt of mineral wool fibres. The mineral wool fibres may comprise glass wool fibres and/or stone wool fibres (also called rock wool fibres). The glass mineral wool fibres may comprise: >55 wt-% silicon oxide (SiO₂) and/or <10 wt-% aluminium oxide (Al₂O₃); and/or an alkali/alkaline-earth ratio of their composition which is ≥1; and/or a combined quantity of CaO and MgO <20 wt-%; and/or a combined quantity of Na₂O and K₂O>8% wt. The glass wool fibres may have a softening point in the range 600-750° C., notably in the range 650-700° C. The stone mineral fibres may comprise: between 30 and 55 wt-% SiO₂ and/or between 10 and 30 wt-% Al₂O₃; and/or an alkali/alkaline-earth ratio of their composition which is <1; and/or a combined quantity of CaO and MgO ranging from 20 to 35 wt-%; and/or a combined quantity of Na₂O and K₂O<8 wt %; and/or a total iron content expressed as Fe₂O₃ of between 4 and 10 wt-%. The stone wool fibres may have a softening point in the range 900-1200° C., notably in the range 1000-1100° C. The amount of shots (or beads) in the mineral wool blanket may be ≤1% wt, a shot being defined as a particle having a largest apparent diameter of less than 60 μm.

The mineral wool blanket and/or the mineral wool insulating product may have a thickness in the range from 20 to 300 mm, especially in the range from 60 to 260 mm. It may have a density which is ≥8 kg/m³, ≥10 kg/m³ or ≥15 kg/m³ and/or ≤250 kg/m³, ≤200 kg/m³, ≤180 kg/m³ or ≤120 kg/m³. Notably when the mineral wool blanket comprises glass wool fibres, the density of the mineral wool blanket may be in the range 8-55 kg/m³, preferably in the range 10-40 kg/m³. Notably when the mineral wool blanket comprises stone wool fibres, the density of the mineral wool blanket may in the range 25-250 kg/m³, notably in the range 50-120 kg/m³. The present invention provides a method which is adapted to secure a facing to a mineral wool blanket having any of the aforementioned densities; the compatibility with lower density mineral wool blankets to which securing of a facing is often more problematic is particularly advantageous.

The mineral wool insulating product may comprise ≥50% wt, ≥60% wt, ≥70% wt, 80%, ≥90% or ≥95% of mineral fibres. The mineral wool fibres may have an average diameter of ≤10 μm or ≤8 μm, for example in the range from 3 to 6 μm. The mineral wool fibres may have a length of ≤1 cm or ≤500 μm or ≤100 μm or ≤50 μm.

A peel test comprising removing a facing that has been secured to the mineral wool blanket by peel the facing away from the mineral wool blanket may be used to assess the level of adhesion between the facing and mineral wool blanket. When the facing is removed from the mineral wool blanket in a peel test, the proportion of the surface area of the facing to which mineral wool fibres remain secured may be ≥70%, preferably ≥80%, more preferably ≥90% and even more preferably ≥95% of the total surface of the facing. This retention of fibres to the facing during a peel test indicates that failure occurs in the body of the mineral wool blanket rather than at the interface between the mineral wool blanket and the facing.

In a preferred embodiment, the method of manufacturing comprises applying a thermoset adhesive, notably an epoxy-polyester adhesive, in particulate form to a major surface of a facing comprising a glass veil, subsequently securing the thermoset adhesive in particulate form to the major surface of the facing comprising a glass veil by applying heat to provide an adhesive coated surface of the facing and then securing the adhesive coated surface of the facing comprising a glass veil to one of the main surfaces of a glass wool mineral wool blanket, by application of heat and pressure, notably by a heated drum.

An embodiment of the invention will now be described, by way of example only with reference to the accompanying drawing of which:

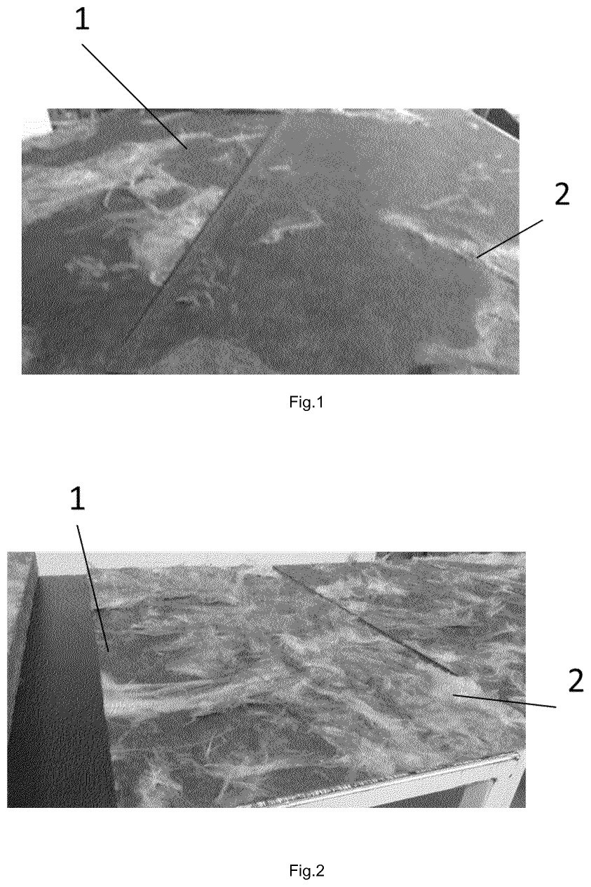

FIG. 1 is an image of a facing removed by a peel test from a mineral wool blanket not in accordance with the invention; and

FIG. 2 is an image of a facing removed by a peel test from a mineral wool blanket in accordance with the invention.

A glass veil having an area weight of about 60 g/m² is positioned on a conveyor. The veil comprises glass fibres with a cured urea extended formaldehyde resin and a black pigment.

A thermoset adhesive in particulate form for which ≥90% of the particles by weight have a particle size in the range 20 μm to 550 μm is deposed over substantially the entire major surface of the glass veil in an amount of about 10 g/m². The thermoset adhesive in particulate form (Starpow 100 from Dakota) is then secured to the major surface of the glass veil by passing the uncoated surface of the facing over a heated calender held at a temperature of about 125° C., which partially melts and secures the particulate adhesive to provide a glass veil having an adhesive coated surface.

The glass veil with the adhesive coated surface is cooled at ambient temperature (about 20° C.) before being packaged by rolling the glass veil in the form of a cylinder. The packaged glass veil is transported to a different location where it is unpackaged and unrolled.

The glass veil is then applied to the major upper surface of a glass wool blanket running continuously on a conveyor, the blanket comprising freshly formed glass fibres 2 and uncured binder. The glass veil and the glass wool blanket pass through a curing oven, the glass veil being pressed against a major surface of the mineral wool blanket by the flights of the curing oven. The temperature in the curing oven (up to about 250° C.) cures the binder of the mineral wool blanket and secures the facing to the major surface of the mineral wool blanket via the particulate adhesive. The glass wool mineral wool blanket has a density of about 19.5 kg/m³.

Once fully cooled having passed through the curing oven, the facing 1 of the glass wool mineral wool blanket is removed by hand in a peel test. The surface of the facing that had been attached to the mineral wool blanket is shown in FIG. 2.

A second glass wool mineral wool blanket was manufactured in the same way, other than the adhesive used to secure the facing to the mineral wool blanket. In the case of the second mineral wool blanket, the facing was secured to the mineral wool blanket by a PVOH adhesive applied to the facing as a liquid in the form of bands having a width of 5 mm spaced by a distance of 80 mm just before application of the facing to the mineral wool blanket and passage through the curing oven. Once fully cooled having passed through the curing oven, the facing 1 of the glass wool mineral wool blanket is removed by hand in a peel test. The surface of the facing that had been attached to the mineral wool blanket is shown in FIG. 1.

In FIG. 2 the portion of the surface area of the facing to which the fibres are still secured after the peel test is about 75% of the total surface area, whilst the portion in FIG. 1 is less than 25%.

1. Method of manufacturing a mineral wool insulating product comprising a mineral wool blanket having a facing secured to one of its main surfaces, the method comprising securing an adhesive coated surface of the facing to one of the main surfaces of the mineral wool blanket by application of heat and pressure wherein the adhesive coated surface of the facing comprises an adhesive in particulate form.

2.-15. (canceled)

16. The method of claim 1, wherein the method comprising, sequentially:
a) applying the adhesive in particulate form to a major surface of the facing;
b) securing the adhesive in particulate form to the major surface of the facing by applying heat to provide the adhesive coated surface of the facing;
c) the securing of the adhesive coated surface of the facing to the main surfaces of the mineral wool blanket by application of heat and pressure.

17. The method of claim 16, further comprising
packaging the facing to which the adhesive in particulate form has been secured by rolling the facing in the form of a cylinder and subsequently unpackaging the facing prior to securing the adhesive coated surface of the facing to one of the main surfaces of the mineral wool blanket by application of heat and pressure.

18. The method of claim 1,
wherein the adhesive in particulate form is selected from: polyethylene, polypropylene, copolyester PES, EVA, epoxy-polyester, a thermosetting adhesive and combination thereof.

19. The method of claim 1,
wherein the adhesive in particulate form comprises a thermosetting adhesive; and
wherein securing the adhesive coated surface of the facing to one of the main surfaces of the mineral wool blanket by application of heat and pressure comprises curing the thermosetting adhesive.

20. The method of claim 1,
wherein securing the adhesive coated surface of the facing to one of the main surfaces of the mineral wool blanket is carried out by passing the mineral wool blanket and the facing through a portion of the curing oven at a temperature of ≥180° C. for a duration which is ≥20 seconds.

21. The method of claim 20, wherein passing the mineral wool blanket and the facing through a portion of the curing oven at a temperature of ≥180° C. is carried out for a duration ≤5 minutes.

22. The method of claim 1,
wherein securing the adhesive coated surface of the facing to one of the main surfaces of the mineral wool blanket comprises pressing the facing between the mineral wool blanket and heated drum.

23. The method of claim 22,
wherein the heated drum has a surface temperature of ≥40° C. and wherein the facing is pressed between the mineral wool blanket and heated drum for a duration which is ≥2 seconds.

24. The method of claim 23,
wherein the facing is pressed between the mineral wool blanket and heated drum for a duration which is ≤30 seconds.

25. The method of claim 1,
wherein securing the adhesive in particulate form to the major surface of the facing comprises heating the adhesive in particulate form to a temperature which is ≥50° C. and ≤250° C.

26. The method of claim 1,
wherein the adhesive in particulate form has a particle size such that ≥90% by weight of the particles have a particle size in the range 20 μm to 550 μm.

27. The method of claim 1,
wherein the adhesive in particulate form has a particle size such that ≥90% by weight of the particles have a particle size in the range 70 μm to 350 μm.

28. The method of claim 1,
wherein the amount of adhesive in particulate form applied to the facing is ≥5 g/m² and ≤30 g/m².

29. The method of claim 1,
wherein the facing comprises a facing selected from a woven veil, a woven glass veil, a non-woven veil, a non-woven glass veil, a coated veil, a kraft layer, a metallised layer, an aluminium layer, a PET layer and a fibrous reinforcing scrim.

30. The method of claim 1,
wherein the facing comprises a colouring agent which darkens the facing.

31. The method of claim 1,
wherein, prior to application of the adhesive in particulate form, the facing has a surface weight in the range 30 g/m² to 350 g/m².

32. Method of securing a facing having a surface weight in the range 30 g/m² to 350 g/m² to a main surface of a mineral wool blanket comprising sequentially:
a) applying an adhesive in particulate form to a major surface of the facing, the adhesive in particulate from being selected from polyethylene (PE), polypropylene (PP), copolyester PES, EVA, epoxy-polyester, a thermosetting adhesive and combination thereof; the adhesive in particulate form having a particle size such that ≥90% by weight of the particles have a particle size in the range 20 μm to 550 μm; and wherein the amount of adhesive in particulate form applied to the facing is ≥5 g/m² and ≤30 g/m²;
b) securing the adhesive in particulate form to the major surface of the facing by applying heat to provide an adhesive coated surface of the facing; and
c) securing the adhesive coated surface of the facing to the main surfaces of the mineral wool blanket by application of heat and pressure.
